(19) United States
(12) Patent Application Publication
(10) Pub. No.: US 2015/0108828 A1
(43) Pub. Date: Apr. 23, 2015

(54) METHOD OF REMANUFACTURING A WHEEL HOUSING

(71) Applicant: Caterpillar Inc., Peoria, IL (US)

(72) Inventors: Donald G. Clark, Iuka, MS (US); Kristin A. Schipull, Moorhead, MN (US); Deven J. Efta, Fargo, ND (US); Sheldon Lee David Zick, Osage, MN (US); Jamie Krank, West Fargo, ND (US)

(73) Assignee: Caterpillar Inc., Peoria, IL (US)

(21) Appl. No.: 14/058,462

(22) Filed: Oct. 21, 2013

(51) Int. Cl. B60B 35/16; B23P 6/00

(52) U.S. Cl. CPC B60B 35/163; B23P 6/00; B60B 2310/228; B60Y 2200/20
USPC 301/137; 29/402.01

(57) ABSTRACT

A method of remanufacturing a wheel housing flange is provided. The wheel housing flange includes a hole configured to receive a fastener, the hole extending from a first face of the wheel housing flange to a second face of the wheel housing flange. The method includes machining the hole to a machined diameter larger than an original diameter. The method further includes securing a first insert in the hole adjacent to the first face. The method further includes securing a second insert in the hole adjacent to the second face.

### TECHNICAL FIELD

The present disclosure relates to a wheel housing, and more particularly, to a method of remanufacturing a wheel housing.

### BACKGROUND

Wheel housings are used in various machines, such as, off-highway truck. Typically, wheel housing includes one or more flanges having multiple holes. The wheel housing is mounted onto a machine by fasteners passing through the holes.

During operation, the holes or parts of the flange may get damaged. For example, the holes may develop cracks. Further, the holes may undergo wear which may change the dimensions. Various parts of the flange may also undergo wear or develop cracks. In such cases, the entire wheel housing may have to be replaced.

U.S. Pat. No. 7,622,178 discloses an assembly including a composite flange, an insert, an adhesive and a support. The composite flange has at least one damaged aperture. The insert is positioned in the damaged aperture and extends therefrom to provide compressive load transfer through the composite flange. The adhesive is positioned directly on at least a portion of the composite flange proximate the damaged aperture. The support is positioned over the adhesive and contacts the insert.

### SUMMARY

In one aspect of the present disclosure, a method of remanufacturing a wheel housing flange is provided. The wheel housing flange includes a hole configured to receive a fastener, the hole extending from a first face of the wheel housing flange to a second face of the wheel housing flange. The method includes machining the hole to a machined diameter larger than an original diameter. The method further includes securing a first insert in the hole adjacent to the first face. The method further includes securing a second insert in the hole adjacent to the second face.

Other features and aspects of this disclosure will be apparent from the following description and the accompanying drawings.

### BRIEF DESCRIPTION OF THE DRAWINGS

FIG. 1 is a perspective view of an exemplary wheel housing;

FIGS. 2A, 2B and 2C are respectively front perspective, rear perspective and sectional views of a hole on the wheel housing;

FIGS. 3A and 3B respectively illustrate front perspective and sectional views of the hole of FIG. 2 after machining;

FIGS. 4A and 4B respectively illustrate front perspective and sectional views of the hole after counterboring;

FIGS. 5A and 5B respectively are top and sectional views of a first insert, in accordance with an embodiment of the present disclosure;

FIG. 6 is a sectional view of the hole with the first insert secured;

FIG. 7 shows a sectional view of the hole after threading;

FIG. 8 illustrates a side view of a second insert being secured in the hole, according to an embodiment of the present disclosure;

FIG. 9 illustrates a side view of a second insert being secured in the hole, according to another embodiment of the present disclosure;

FIG. 10 illustrates a sectional view of the second insert of FIG. 8 secured in the hole, according to an embodiment of the present disclosure;

FIG. 11 illustrates a sectional view of the second insert of FIG. 9 secured in the hole, according to another embodiment of the present disclosure;

FIGS. 12, 13, and 14 respectively illustrate sectional views of various machined states of the second insert of FIG. 8 after being secured in the hole;

FIG. 15 illustrates a fragmented sectional view of a shoulder portion of the wheel housing of FIG. 14 after machining;

FIG. 16 illustrates a fragmented sectional view of a third insert secured to the shoulder portion of FIG. 15;

FIG. 17 illustrates a fragmented sectional view of the third insert of FIG. 16 after machining;

FIG. 18 illustrates sectional view of machined state of the second insert of FIG. 11;

FIG. 19 illustrates a fragmented sectional view of a shoulder portion of the wheel housing of FIG. 18 after machining;

FIG. 20 illustrates a fragmented sectional view of a third insert secured to the shoulder portion of FIG. 19;

FIG. 21 illustrates a fragmented sectional view of the third insert of FIG. 20 after machining; and

FIG. 22 is a method of remanufacturing the wheel housing of FIG. 2 in accordance with an embodiment of the present disclosure.

### DETAILED DESCRIPTION

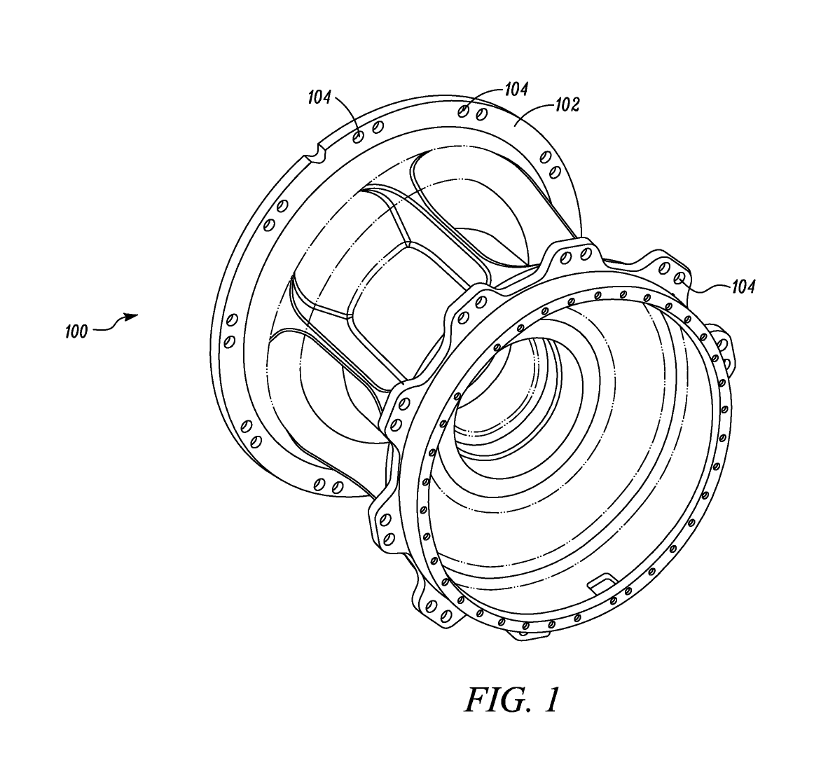

The present disclosure relates to wheel housings, and more particularly, to a method of remanufacturing a wheel housing flange. FIG. 1 shows a perspective view of an exemplary wheel housing 100 showing a wheel housing flange 102 in which disclosed embodiments may be implemented.

The wheel housing 100 may be of any type. In one embodiment, the wheel housing 100 may be used in an off-highway truck (not shown), for example, a mining truck (not shown). In another embodiment, the wheel housing 100 may be used in a motor grader (not shown). However, in alternative embodiments, the wheel housing 100 may be used in a landfill compactor, a wheel loader or other types of machines typically used in the construction and automobile industry.

In one exemplary embodiment, the wheel housing 100 may include one or more holes 104 integral with the wheel housing flange 102. The holes 104 are configured to receive fasteners (not shown). The fasteners may be used for mounting the wheel housing 100 onto a machine.

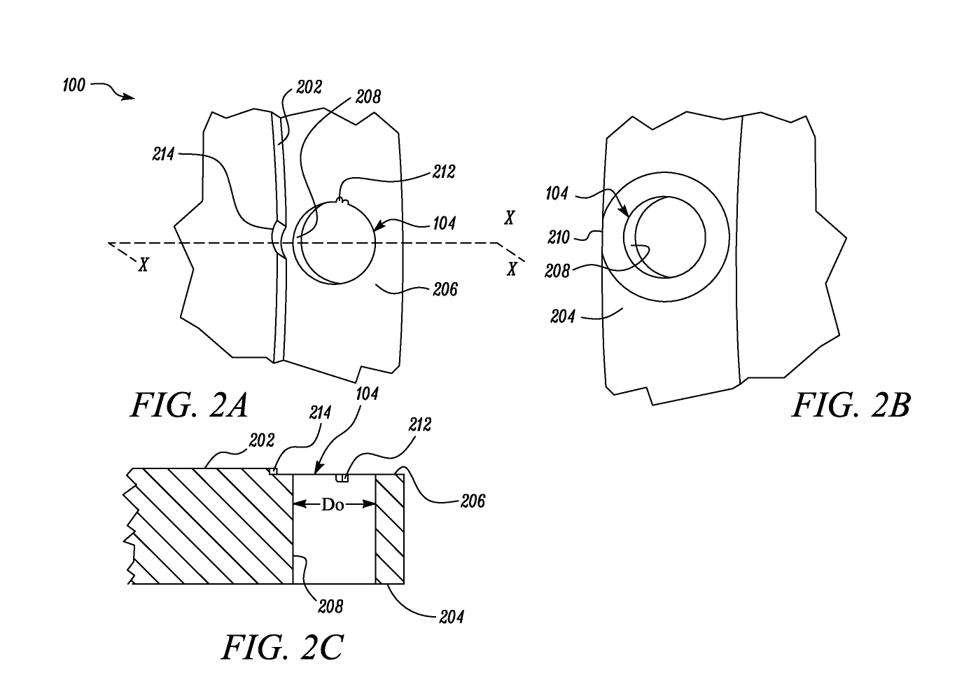

Various details pertaining to remanufacturing the wheel housing flange 102 will be made hereinafter with reference to FIGS. 2-22.

FIGS. 2A, 2B and 2C illustrate various views of the wheel housing 100, in accordance with an embodiment of the present disclosure. The wheel housing 100 includes the holes 104. The hole 104 has an original diameter Do. The hole 104 further extends from a first face 204 of the wheel housing flange 102 to a second face 206 of the wheel housing flange 102. Further, an elongate portion 208 defines an inner surface of the hole 104. A shoulder 202 is located on the first face 204 of the wheel housing flange 102 adjacent to the hole 104. FIGS. 2A, 2B and 2C further illustrate multiple defects present on the hole 104. The multiple defects may include an outer circumferential defect 210 present on the first face 204, an inner circumferential defect 212 present on the second face 206, and a shoulder defect 214 present on a shoulder portion 202 of the second face 206. The multiple defects of the hole 104, as shown in FIGS. 2A, 2B and 2C, are purely exemplary in nature, and the hole 104 may have any other number or type of defects.

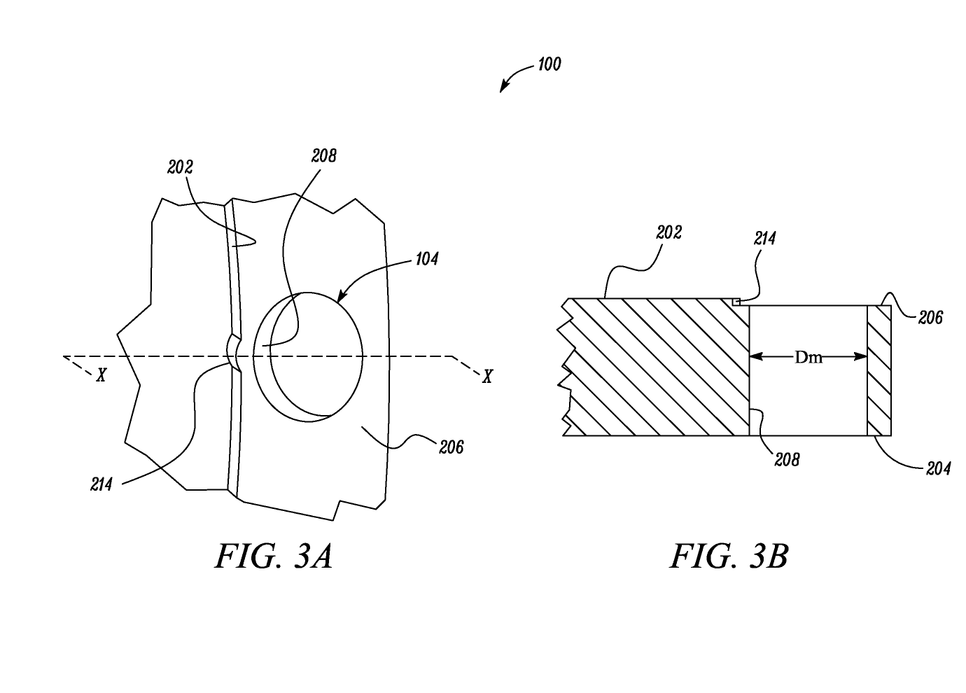

FIGS. 3A and 3B illustrate the hole 104 on which a machining operation has been performed, in accordance with an embodiment of the present disclosure. The machining operation has provided the hole 104 with a machined diameter Dm. In an embodiment, the machined diameter Dm is larger than the original diameter Do. The machining of the hole 104 from the original diameter Do to the machined diameter Dm may be done on a Computer Numerical Control (CNC) machine. Alternatively, any other type of machines capable of similar machining operations may be used.

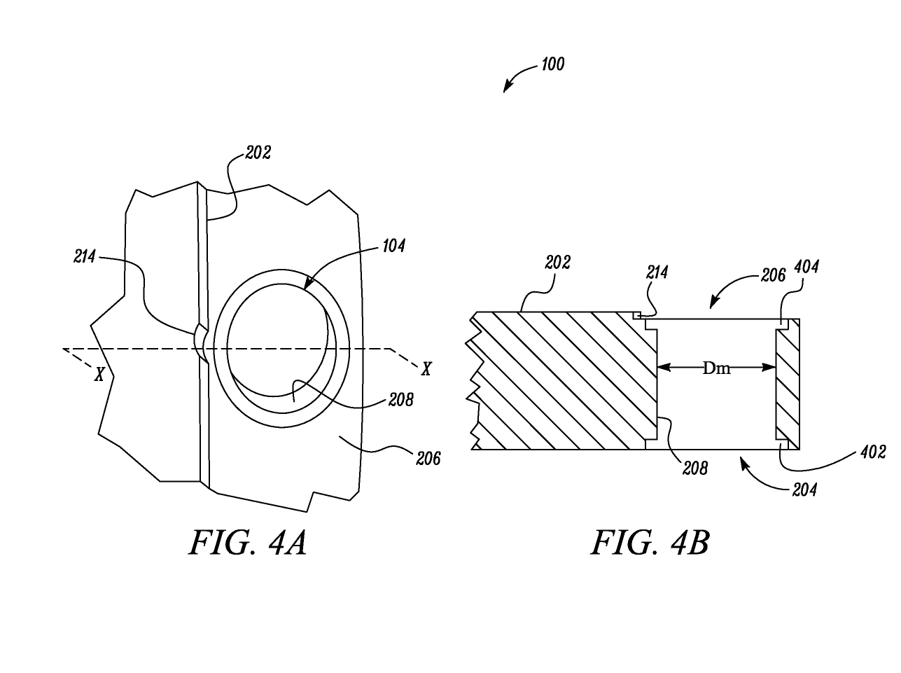

FIGS. 4A and 4B shows the hole 104 on which a counterboring operation has been performed, in accordance with an embodiment of the present disclosure. The counterboring operation has provided the hole 104 with a first counterbore 402 adjacent to the first face 204, and a second counterbore 404 adjacent to the second face 206. The elongate portion 208 of the hole 104 is disposed between the first counterbore 402 and the second counterbore 404. The counterboring operation is performed using a counterboring tool. In an embodiment, the counter bore tool may be a LOCK-N-STITCH® counterboring tool. In alternative embodiments, other type of tools capable of similar counterboring operations may be used. Further, dimensions of the first counterbore 402 and the second counterbore 404 may be similar or different.

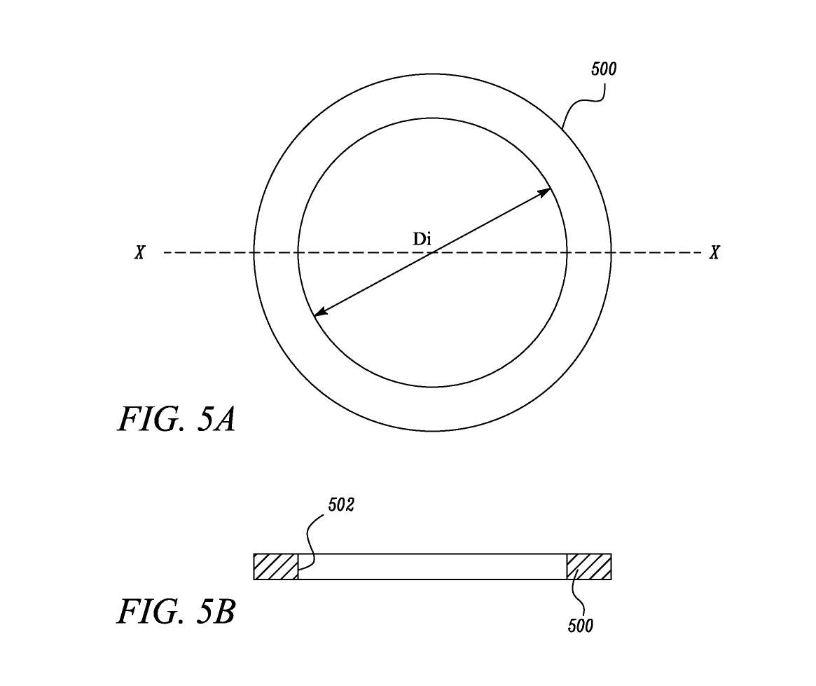

FIGS. 5A and 5B illustrate a first insert 500, in accordance with an embodiment of the present disclosure. The first insert 500 is configured to be received by the first counterbore 402 adjacent to the first face 204. The first insert 500 has an inner surface 502. Further, an inner diameter Di of the first insert 500 may or may not be substantially similar to the machined diameter Dm.

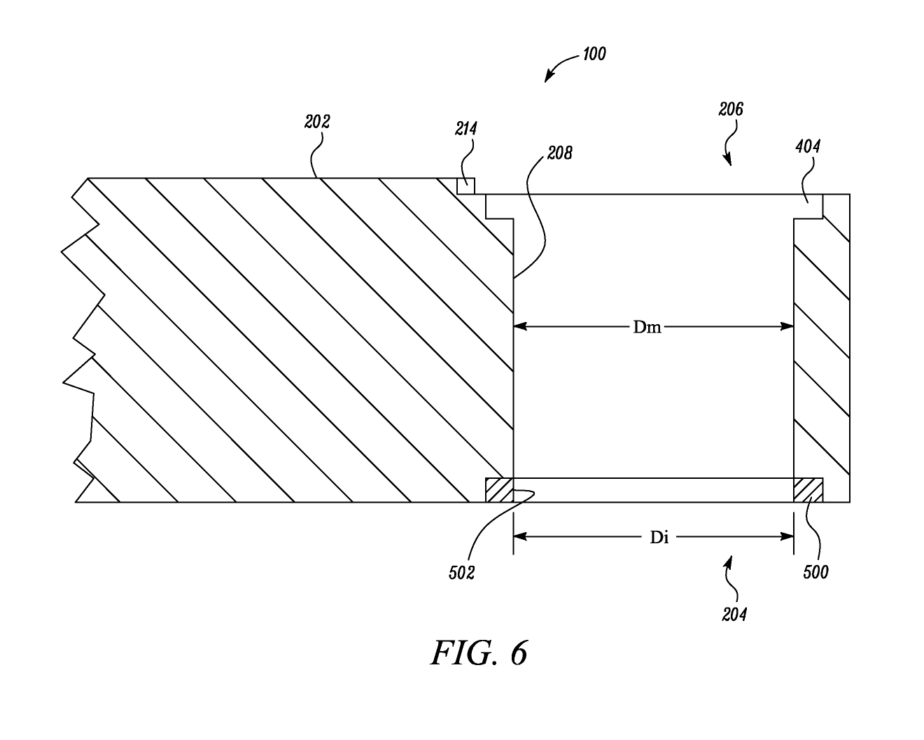

As shown in FIG. 6, the first insert 500 may be press-fitted in the first counterbore 402. An adhesive is applied to the first insert 500 in order to secure the first insert 500 in the first counterbore 402. The adhesive may be LOCTITE®, or any other acrylate based adhesive.

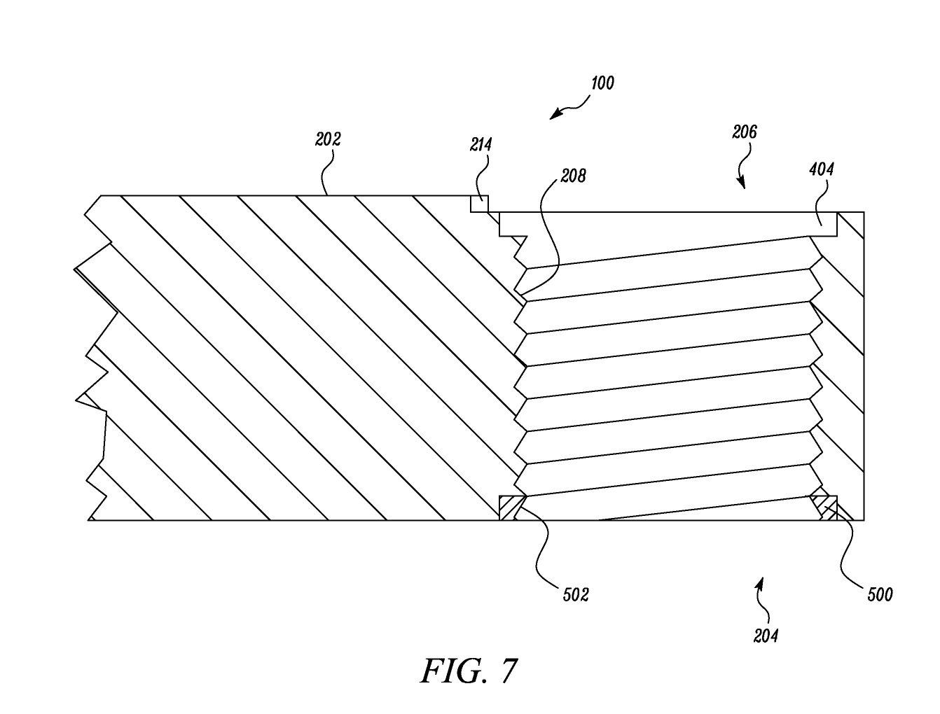

FIG. 7 illustrates the elongate portion 208 of the hole 104 and the inner surface 502 of the first insert 500 on which a machining operation has been performed, according to an embodiment of the present disclosure. The machining of the elongate portion 208 of the hole 104 and the inner surface 502 of the first insert 500 includes a threading operation. The threading operation is performed on the hole 104 so as to thread the elongate portion 208 along with the inner surface 502 of the first insert 500. In an embodiment, the threading operation is performed on the hole 104 using a tapping tool. In an embodiment, the tapping tool may be a LOCK-N-STITCH® tap. In alternative embodiments, other type of tools capable of similar threading operations may be used.

In an alternative embodiment (not shown), a machining operation may be performed only on the inner surface 502 of the first insert 500 such that the inner diameter of the first insert 500 may be changed to the machined diameter Dm of the hole 104. This machining operation may be performed in case the original inner diameter Di of the first insert 500 is different from the machined diameter Dm of the hole 104.

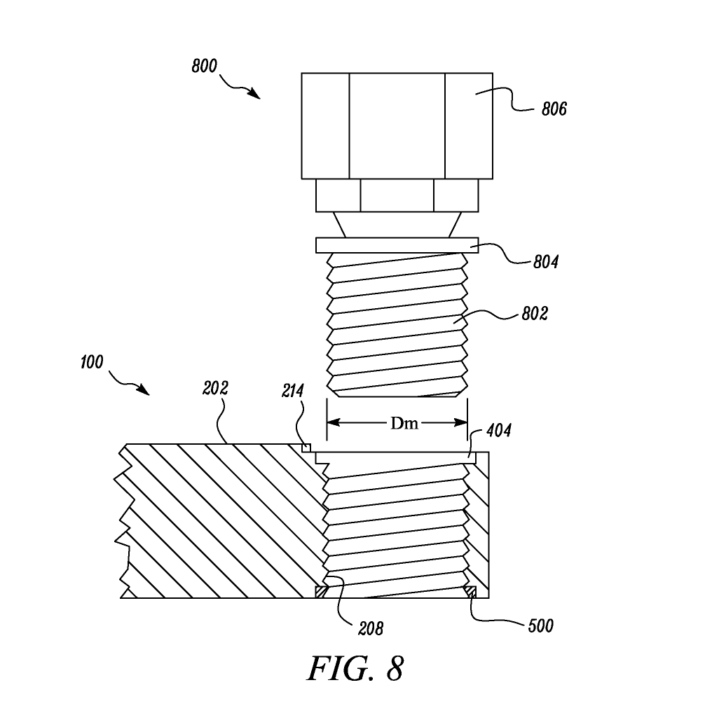

FIG. 8 illustrates a second insert 800 being inserted into the hole 104, according to an embodiment of the present disclosure. The second insert 800 includes a flanged portion 804, a threaded portion 802 protruding from the flanged portion 804, and a detachable portion 806 protruding from the flanged portion 804 in a direction opposite to that of the threaded portion 802. In an embodiment, a diameter of the threaded portion 802 is substantially equal to the machined diameter Dm of the hole 104. Further, external threads of the threaded portion 802 are configured to mate with the internal threads of the elongate portion 208 and the first insert 500. Moreover, the flanged portion 804 is configured to be secured with the second counterbore 404. In an embodiment, the second insert 800 may be a LOCK-N-STITCH® plug. In alternative embodiments, the second insert 800 may be a plug of similar configuration.

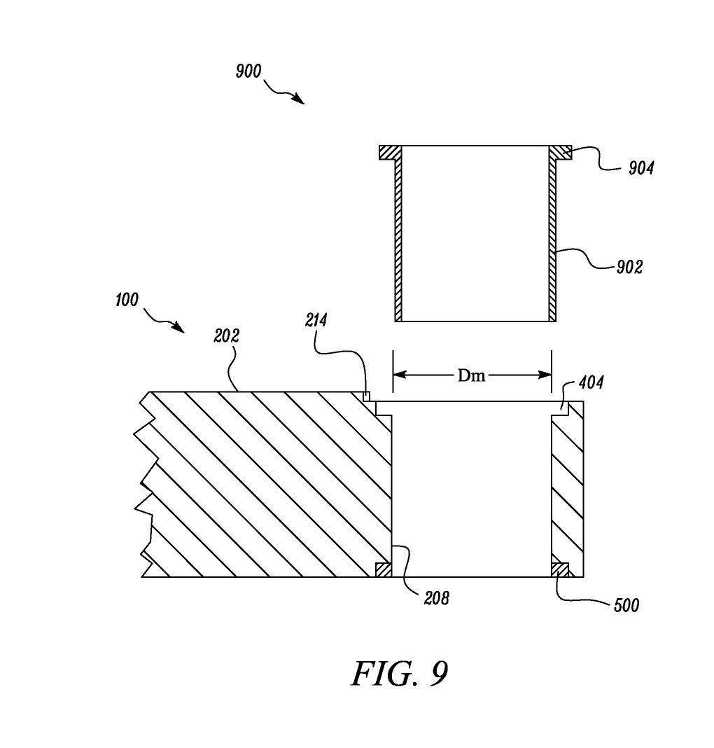

In another aspect of the present disclosure, as show in FIG. 9, the second insert 900 has a flanged hollow cylindrical shape. Specifically, the second insert 900 includes a flanged portion 904 and a cylindrical portion 902 protruding from the flanged portion 904. A diameter of the cylindrical portion 902 may be substantially equal to the machined diameter Dm of the hole 104. In an embodiment, the cylindrical portion 902 is configured to be secured to the elongate portion 208. Further in an embodiment, the flanged portion 904 is configured to be secured to the second counterbore 404. The cylindrical portion 902 and the flanged portion 904 may be first press-fitted to the elongate portion 208 and the second counterbore 404 respectively. Subsequently, an adhesive may be used to secure the second insert 900 in the hole 104. The adhesive may be Loctite®, or any other acrylate based adhesive.

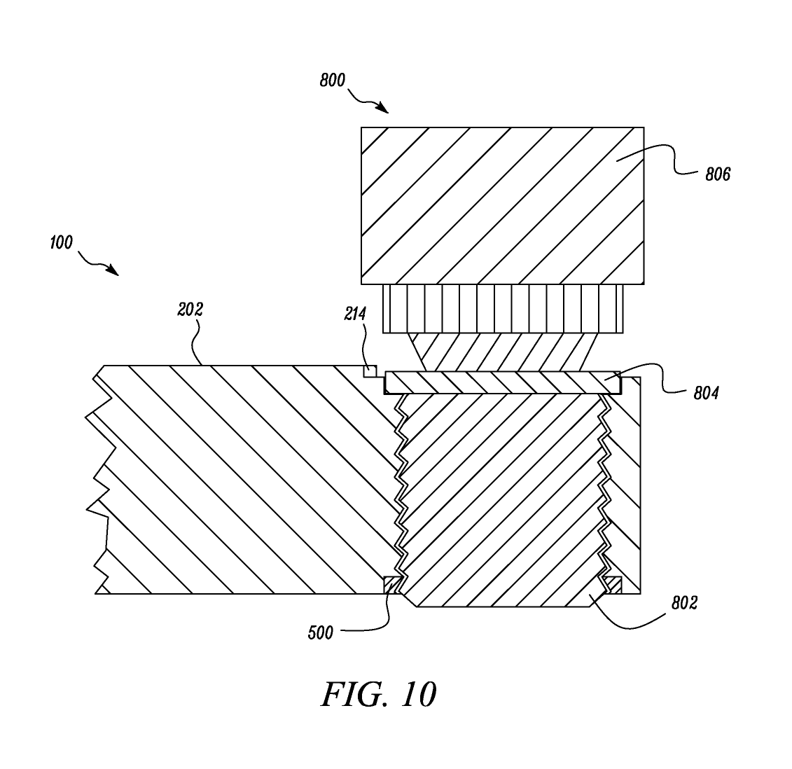

FIG. 10 illustrates the second insert 800 secured in the hole 104 through the second face 206. In an embodiment, the second insert 800 may be torque wrenched into the hole 104. An adhesive is applied to the second insert 800 in order to secure the second insert 800 in the hole 104. The adhesive may be LOCTITE®, or any other acrylate based adhesives. As illustrated in FIG. 10, the threaded portion 802 may protrude from the first face 204. In an alternative embodiment, the threaded portion 802 may not protrude substantially from the first face 204.

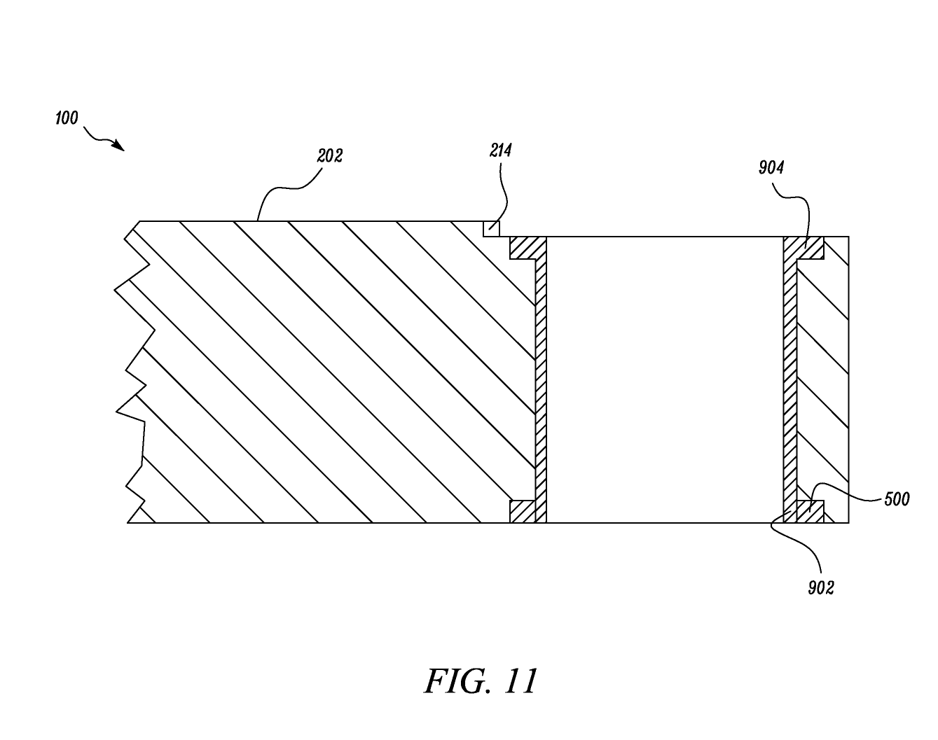

FIG. 11 illustrates the second insert 900 secured in the hole 104 adjacent to the second face 206. The cylindrical portion 902 and the flanged portion 904 of the second insert 900 are respectively secured to the elongate portion 208 and the second counterbore 404 in a press fitted arrangement using an adhesive. The adhesive may be LOCTITE®, or any other acrylate based adhesives. As shown in FIG. 11, the cylindrical portion 902 engages the first insert 500. In an alternative embodiment (not shown), the cylindrical portion 902 may protrude from the first face 204.

The sequence of operations, as described with reference to FIGS. 7, 9 and 11, are exemplary in nature, and in various other embodiments, the sequence may be different. For example, the second insert 900 may be first secured in the hole 104, and subsequently the first insert 500 secured in the first counterbore 402 of the hole 104 and the second insert 900.

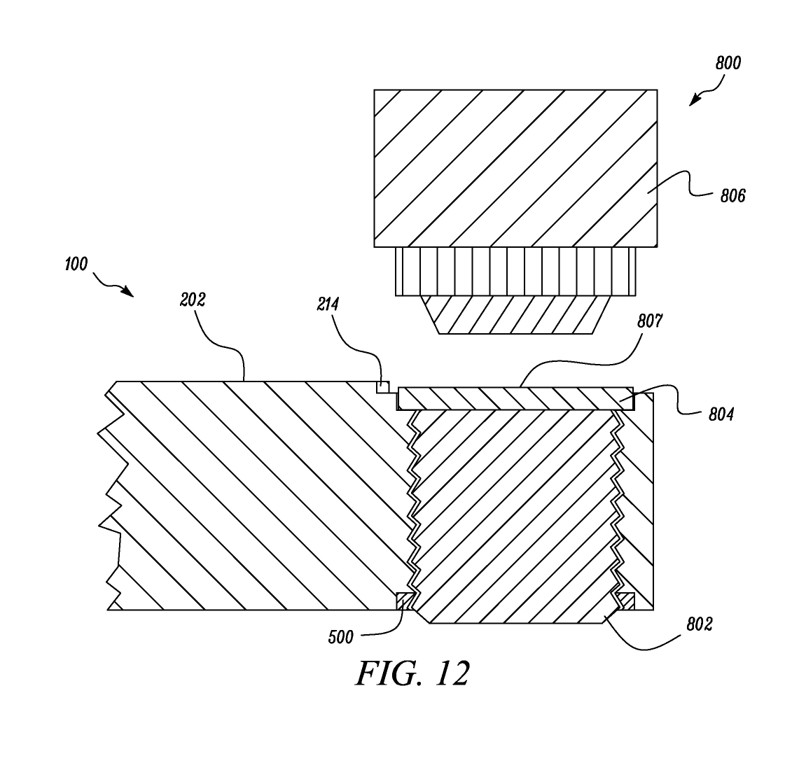

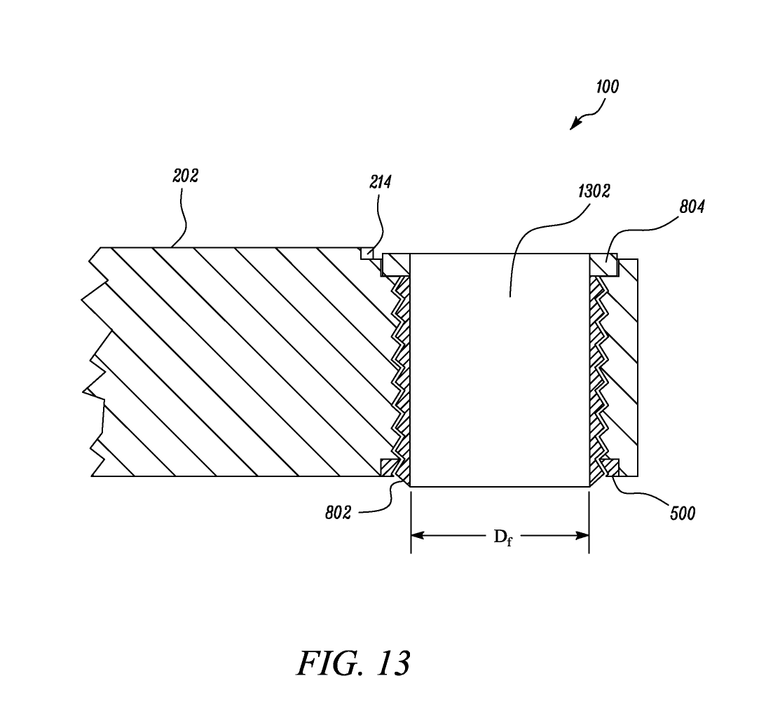

FIG. 12 illustrates the second insert 800 after removal of the detachable portion 806. The removal of the detachable portion 806 may include breakage of the detachable portion 806 from the flanged portion 804 by applying a force. Alternatively, a removable connection (E.g., a threaded connection, a slotted connection etc.) may be provided between the detachable portion 806 and the flanged portion 804 such that the detachable portion 806 may be removed from the flanged portion 804. FIG. 12. further illustrates an upper surface 807 of the flanged portion 804 which is visible after the detachable portion 806 is removed. As shown in FIG. 12, the upper surface 807 of the flanged portion 804 may protrude from the second face 206. In various other embodiments, the upper surface 807 may not substantially protrude from the second face 206. FIG. 13 illustrates a through aperture 1302 formed through the second insert 800. In an embodiment the through aperture 1302 of a final diameter Df may be formed by drilling through the upper surface 807 of the flanged portion 804. Further in an embodiment, the final diameter Df of the through aperture 1302 may be substantially equal to the original diameter Do of the hole 104.

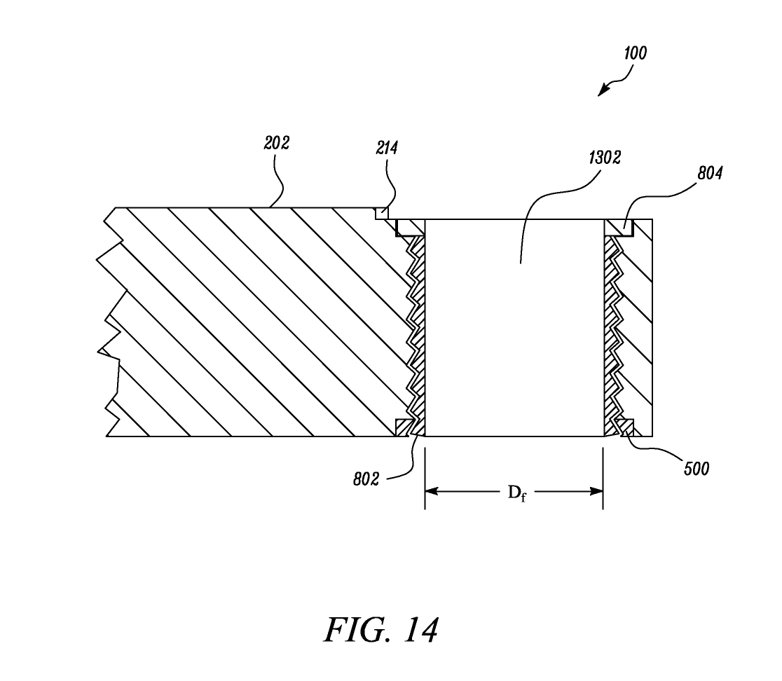

FIG. 14 illustrates the hole 104 after machining of the second insert 800. In an embodiment, the threaded portion 802 may be machined such that the threaded portion 802 is flush with the first face 204 of the wheel housing flange 102. Further, the flanged portion 804 may be machined such that the upper surface 807 of the flanged portion 804 is flush with the second face 206 of the wheel housing flange 102. In alternative embodiments, the second insert 800 may have dimensions such that the second insert 800 is flush with the second face 206 of the wheel housing flange 102. Thus, the machining of the second insert 800 may not be required.

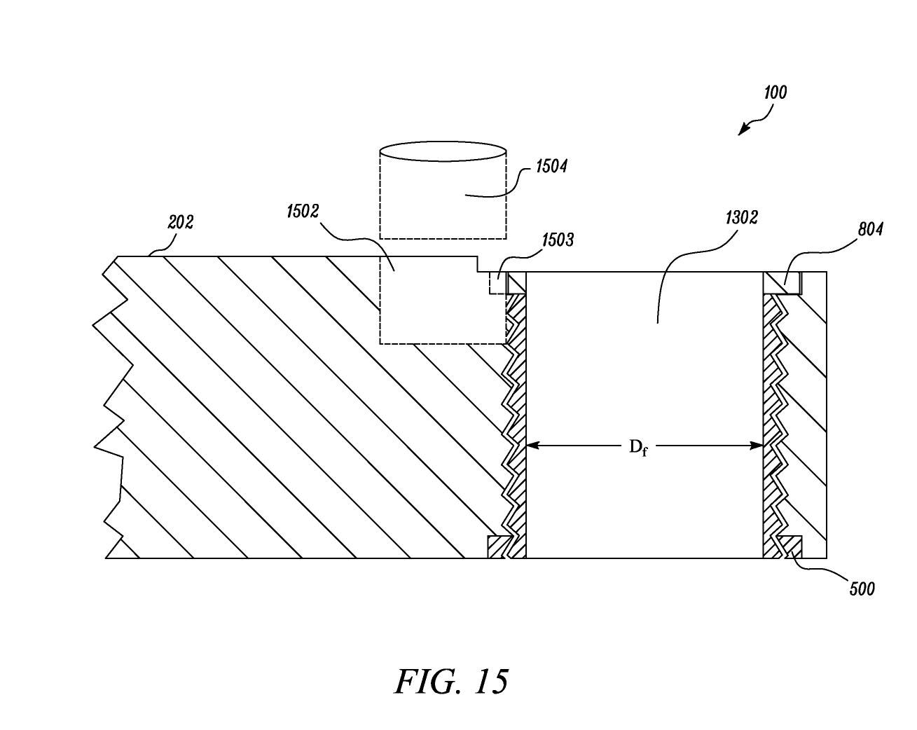

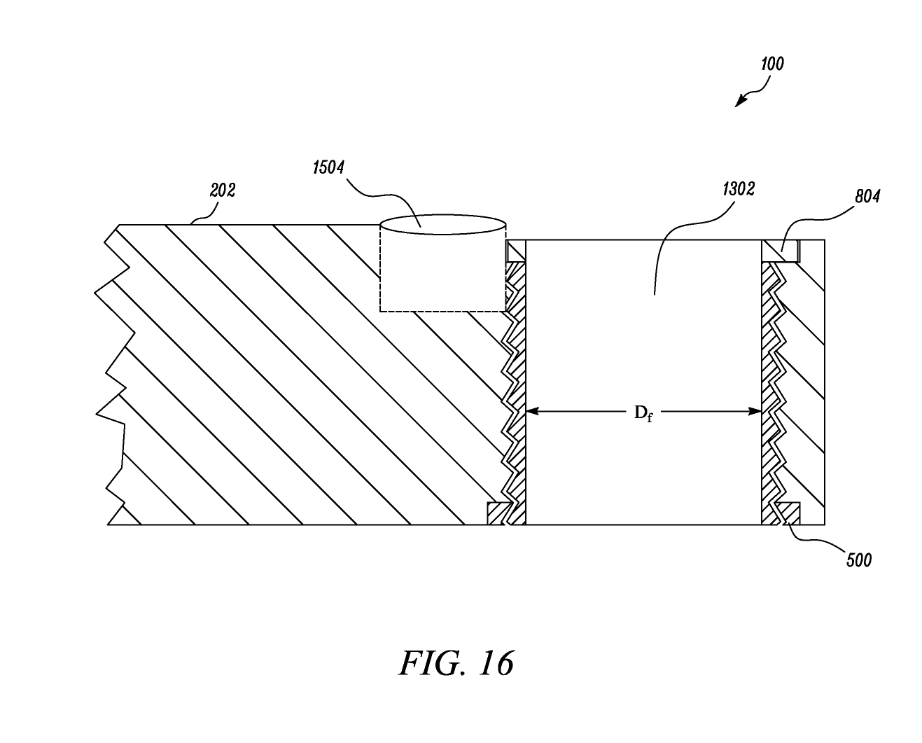

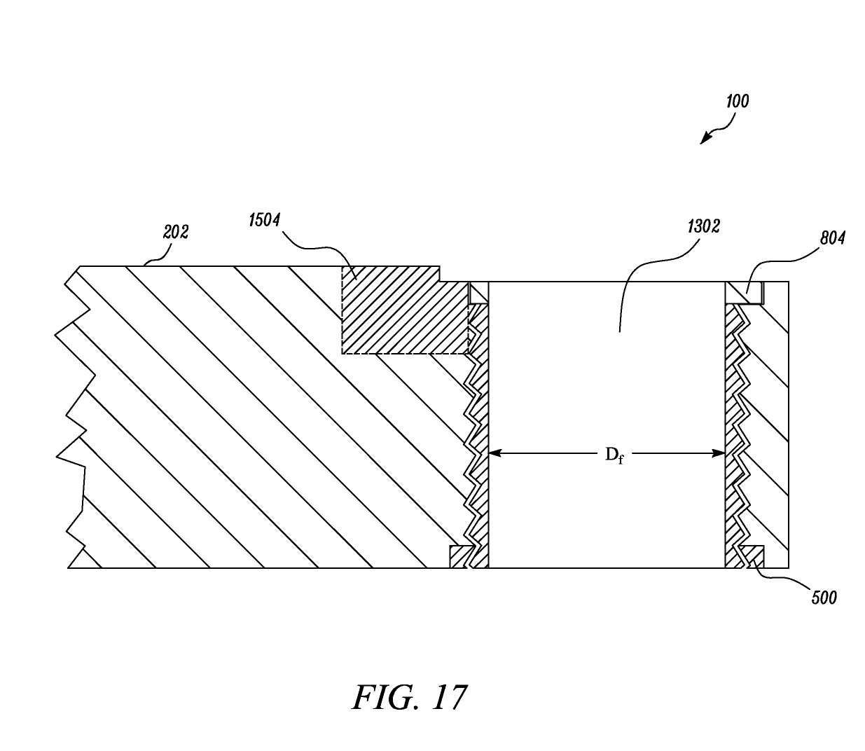

FIGS. 15, 16 and 17 illustrate rectification of the shoulder defect 214, according to an embodiment of the present disclosure. The rectification of the shoulder defect 214 is described with respect to the embodiment where the second insert 800 is secured in the hole 104. As shown in FIG. 15, the shoulder defect 214 is machined to form a recessed portion 1502. The recessed portion 1502 may extend into an adjoining area 1503 of the second insert 800. The recessed portion 1502 may be configured to receive a third insert 1504. Further, as shown in FIG. 16, the third insert 1504 is secured in the recessed portion 1502. The third insert 1504 may be press-fitted to the recessed portion 1502. An adhesive is applied to the third insert 1504 in order to secure the third insert 1504 in the recessed portion 1502. The adhesive may be LOCTITE®, or any other acrylate based adhesives. FIG. 17 illustrates the third insert 1504 after machining. The third insert 1504 is machined to be flush with the adjacent portions of the wheel housing flange 102 to match a profile of the shoulder portion 202. As shown in FIG. 17, a portion of the third insert 1504 is machined flush with the shoulder portion 202, and another portion of the third insert 1504 is machined flush with the second face 206. In alternative embodiments, the third insert 1504 may have dimensions such that the third insert 1504 is flush with the second face 206. Thus, the machining of the third insert 1504 may not be required.

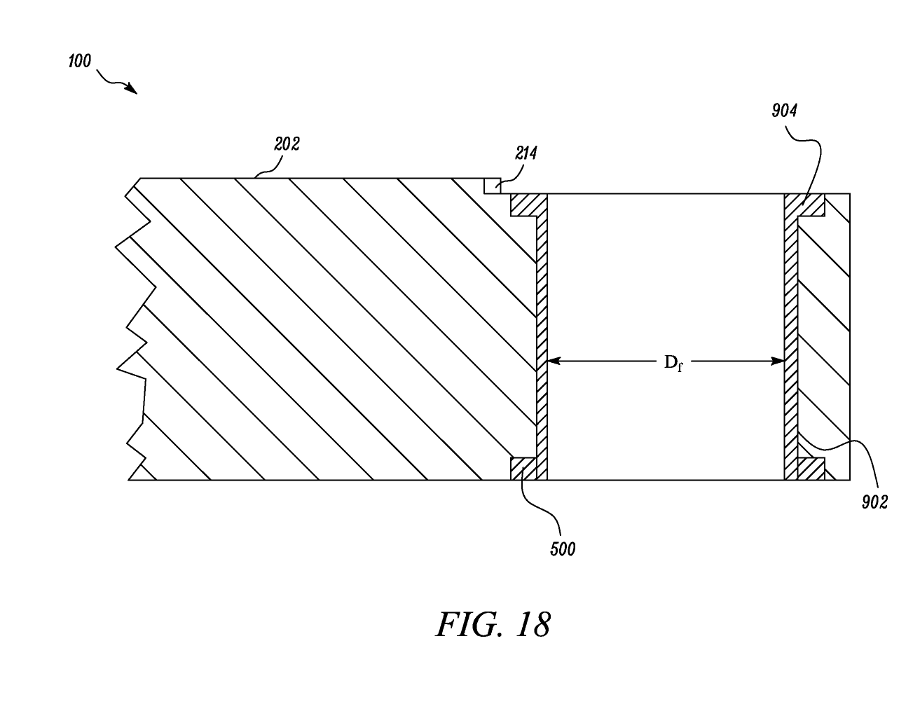

FIG. 18 illustrates the hole 104 after machining of the second insert 900. In an embodiment, the cylindrical portion 902 may be machined such that the cylindrical portion 902 is flush with the first face 204 of the wheel housing flange 102. Further, the flanged portion 904 may be machined such that the upper surface of the flanged portion 904 is flush with the second face 206 of the wheel housing flange 102. In alternative embodiments, the second insert 900 may have dimensions such that the second insert 900 is flush with the second face 206. Thus, the machining of the second insert 900 may not be required.

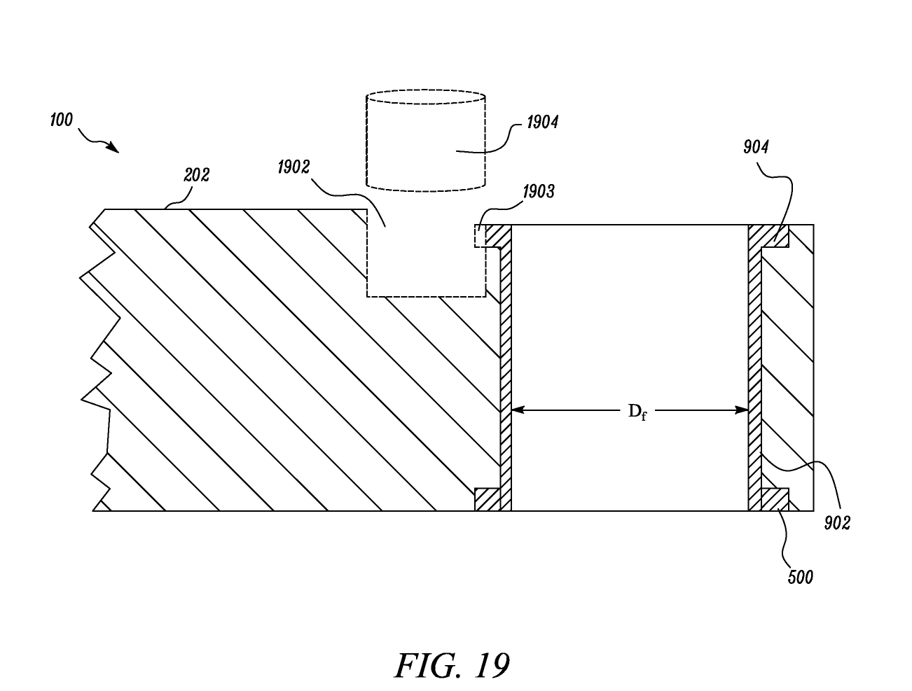

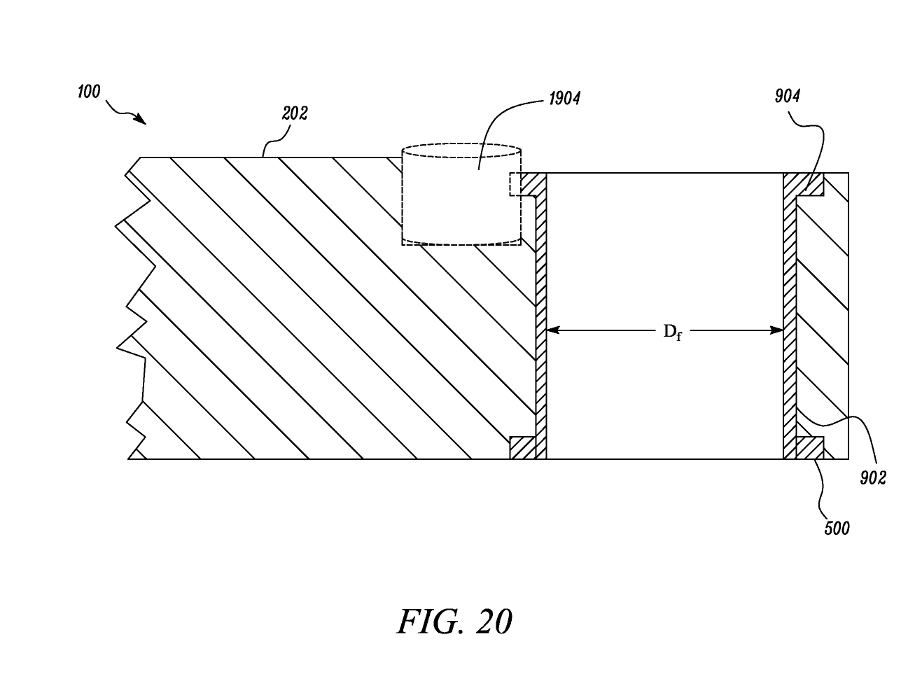

FIGS. 19 and 20 illustrate rectification of the shoulder defect 214, according to an embodiment of the present disclosure. The rectification of the shoulder defect 214 is described with respect to the embodiment where the second insert 900 is secured in the hole 104. As shown in FIG. 19, the shoulder defect 214 is machined to form a recessed portion 1902. The recessed portion 1902 may extend into an adjoining area 1903 of the second insert 900. The recessed portion 1902 may be configured to receive a third insert 1904. Further, as shown in FIG. 20, the third insert 1904 is secured to the recessed portion 1902. The third insert 1904 may be press-fitted in the recessed portion 1902. An adhesive may be applied to the third insert 1904 in order to secure the third insert 1904 in the recessed portion 1902. The adhesive may be LOCTITE®, or any other acrylate based adhesives.

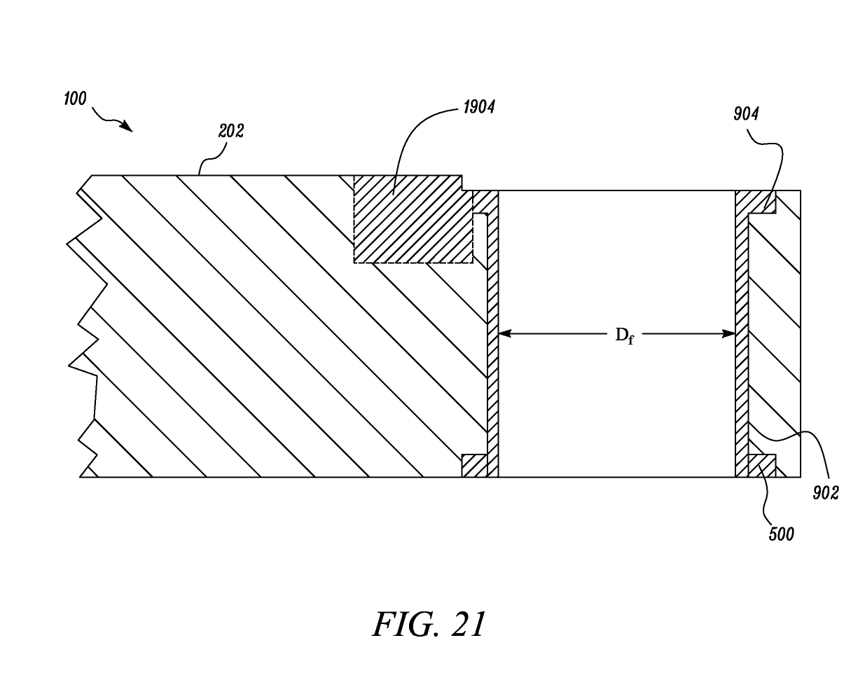

FIG. 21 illustrates the third insert 1904 after machining. The third insert 1904 is machined to be flush with the adjacent portions of the wheel housing flange 102 to match a profile of the shoulder portion 202. As shown in FIG. 21, a portion of the third insert 1904 is machined flush with the shoulder portion 202, and another portion of the third insert 1904 is machined flush with the second face 206. In alternative embodiments, said machining of the third insert 1904 may not be required.

### INDUSTRIAL APPLICABILITY

A wheel housing is configured to be used with machines, such as, off-highway trucks, landfill compactors, wheel loaders, motor graders, or the like. The wheel housing includes one or more wheel housing flanges having multiple holes. The holes are configured to receive fasteners for the mounting the wheel housing to a machine. During operation, the holes and various portions of the wheel housing flange may develop defects. These defects may require the wheel housing to be replaced completely.

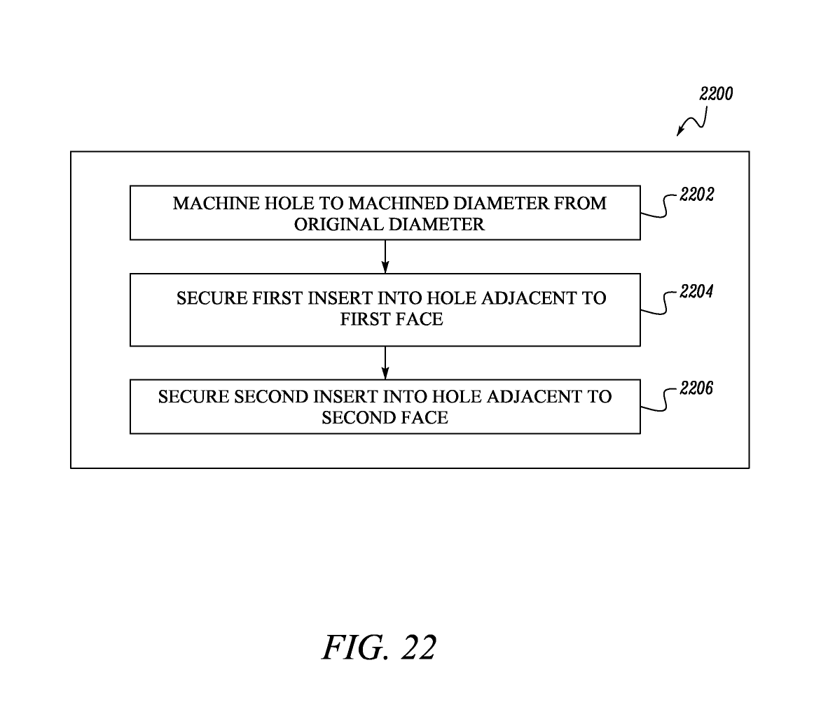

FIG. 22 is a method 2200 of remanufacturing the wheel housing 100 of FIG. 2, according to an aspect of the present disclosure. At step 2202, the method 2200 includes machining the hole 104 to a machined diameter Dm from an original diameter Do. In an embodiment, the machined diameter Dm is larger than the original diameter Do. The method 2200 at step 2202 further includes counterboring the hole 104. The counterboring operation has provided the hole 104 with the first counterbore 402 adjacent to the first face 204, and the second counterbore 404 adjacent to the second face 206.

At step 2204 the method 2200 further includes securing the first insert 500 to the first counterbore 402. At step 2204, the first insert 500 with an adhesive applied on to the first insert 500 may be press-fitted to the first counterbore 402. The adhesive may be LOCTITE®, or any other acrylate based adhesives.

At step 2206 the method 2200 further includes securing the second insert 800 in the hole 104 adjacent to the second face 206 according to an embodiment of the present disclosure. Threads may be machined on the elongate portion 208 of the hole 104 and the inner surface 502 of the first insert 500. The threaded portion 802 is secured to the threads of the elongate portion 208 of the hole 104 and the inner surface 502 of the first insert 500. An adhesive is applied between the hole 104 and the second insert 800. The adhesive may be LOCTITE®, or any other acrylate based adhesives. The method 2200 further includes removing the detachable portion 806 of the second insert 800. The through aperture 1302, extending from the first face 204 to the second face 206, is then machined through the second insert 800. In an embodiment, the through aperture 1302 may be formed by drilling through the upper surface 807 of the flanged portion 804 of the second insert 800.

At step 2206, the method 2200, in an embodiment, further includes machining the first insert 500 flush with the first face 204 of the wheel housing flange 102. The method 2200 further includes machining the second insert 800 flush with the second face 206 of the wheel housing flange 102. The method 2200 further includes rectification of the shoulder defect 214. The shoulder defect 214 is machined to form the recessed portion 1502. Further, the third insert 1504 is secured in the recessed portion 1502. The third insert 1504 is machined to be flush with adjacent portions of the wheel housing flange 102. A portion of the third insert 1504 may be machined flush with the shoulder portion 202, and another portion of the third insert 1504 may be machined flush with the second face 206.

In another embodiment, the method 2200 at step 2206 includes securing a second insert 900 in the hole 104 adjacent to the second face 206. The second insert 900 may be first press fitted in the hole 104 and the first insert 500. An adhesive may be applied between the second insert 900, and the hole 104 and the first insert 500. In other embodiment, step 2204 may follow step 2206. Therefore, the second insert 900 may be first secured in the hole 104. Subsequently, the first insert 500 may be secured in the hole 104 and the second insert 900.

At step 2206 the method 2200, in the another embodiment, further includes machining the first insert 500 flush with the first face 204 of the wheel housing flange 102. The method 2200 further includes machining the second insert 900 flush with the second face 206 of the wheel housing flange 102. The method 2200 further includes rectification of the shoulder defect 214. The shoulder defect 214 is machined to form the recessed portion 1902. Further, the third insert 1904 is secured in the recessed portion 1902. The third insert 1504 is machined to be flush with adjacent portions of the wheel housing flange 102. A portion of the third insert 1504 may be machined flush with the shoulder portion 202 and another portion of the third insert 1504 may be machined flush with the second face 206.

With use of the method 2200 disclosed herein, the hole 104 of the wheel housing 100 may be remanufactured. After remanufacturing, the wheel housing 100 may be again used in a machine. The method 2200 may accomplish remanufacturing of the wheel housing 100 using simple manufacturing processes which may be cost effective as compared to the complete replacement of the wheel housing 100. Thus, complete replacement of the wheel housing 100 may be avoided, thereby saving cost.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

What is claimed is:

1. A method of remanufacturing a wheel housing flange having a hole configured to receive a fastener, the hole extending from a first face of the wheel housing flange to a second face of the wheel housing flange, the method comprising:
machining the hole to a machined diameter larger than an original diameter;
securing a first insert in the hole adjacent to the first face; and
securing a second insert in the hole adjacent to the second face.

2. The method of claim 1, wherein machining the hole includes machining a first counterbore adjacent to the first face and a second counterbore adjacent to the second face, and wherein the first counterbore and second counterbore is separated by an elongate portion of the hole.

3. The method of claim 2, wherein securing the first insert includes press fitting the first insert into the first counterbore.

4. The method of claim 3 further comprising:
machining threads on the elongate portion of the hole and an inner surface of the first insert.

5. The method of claim 4, wherein the second insert includes a flanged portion, a threaded portion protruding from the flanged portion, and a detachable portion protruding from the flanged portion in a direction opposite to that of the threaded portion, the flanged portion being configured to be secured in the first counterbore, wherein securing the second insert in the hole includes:
using the detachable portion to rotate the threaded portion of the second insert in the hole; and
removing the detachable portion.

6. The method of claim 5 further comprising:
machining the second insert to form a through aperture extending from the first face to the second face.

7. The method of claim 6, wherein a diameter of the through aperture is equal to the original diameter of the hole.

8. The method of claim 3, wherein the second insert includes a flanged portion and a cylindrical portion, wherein securing the second insert in the hole includes:
securing the flanged portion in the first counterbore; and
securing the cylindrical portion to the elongate portion of the hole and an inner surface of the first insert.

9. The method of claim 1, wherein securing the first insert and second insert in the hole includes applying an adhesive between each of the first insert and second insert, and the hole.

10. The method of claim 1, wherein the first insert and the second insert are machined flush with the first face and the second face respectively.

11. The method of claim 1 further includes machining a recessed portion in a shoulder of the wheel housing flange located on the second face, the recessed portion extending into an adjoining area of the second insert, the recessed portion configured to receive a third insert.

12. The method of claim 11 further comprising:
securing the third insert in the recessed portion; and
machining the third insert flush with adjacent portions of the wheel housing flange.

13. The method of claim 12, wherein securing the third insert in the recessed portion includes applying an adhesive between the third insert and the recessed portion.

14. A method of remanufacturing a wheel housing flange having a hole configured to receive a fastener, the hole extending from a first face of the wheel housing flange to a second face of the wheel housing flange, the method comprising:
machining the hole to a machined diameter larger than an original diameter;
machining a first counterbore adjacent to the first face and a second counterbore adjacent to the second face, an elongate portion of the hole with the machined diameter disposed between the first counterbore and second counterbore;
press fitting a first insert in the hole adjacent to the first face;
securing a second insert in the hole adjacent to the second face; and
machining the first insert and second insert flush with the first face and the second face respectively.

15. The method of claim 14 further comprising:
machining threads on the elongate portion of the hole and an inner surface of the first insert.

16. The method of claim 15, wherein the second insert includes a flanged portion, a threaded portion protruding from the flanged portion, and a detachable portion protruding from the flanged portion in a direction opposite to that of the threaded portion, the flanged portion being configured to be secured in the first counterbore, wherein securing the second insert in the hole includes:
using the detachable portion to rotate the threaded portion of the second insert in the hole; and
removing the detachable portion.

17. The method of claim 16 further comprising:
machining the second insert to form a through aperture extending from the first face to the second face.

18. The method of claim 14, wherein the second insert comprising a flanged portion and a cylindrical portion, wherein securing the second insert in the hole includes:
securing the flanged portion in the first counterbore; and
securing the cylindrical portion to the elongate portion of the hole and an inner surface of the first insert.

19. The method of claim 14 further comprising:
machining a recessed portion in a shoulder of the wheel housing flange located on the second face, the recessed portion extending into an adjoining area of the second insert;
securing the third insert in the recessed portion; and
machining the third insert flush with adjacent portions of the wheel housing flange.

20. A remanufactured wheel housing flange having a hole configured to receive a fastener, the hole extending from a first face of the wheel housing flange to a second face of the wheel housing flange, the remanufactured wheel housing flange prepared by a process comprising the steps of:
machining the hole to a machined diameter larger than an original diameter;
securing a first insert in the hole adjacent to the first face;
securing a second insert in the hole adjacent to the second face; and
machining the first insert and second insert flush with the first face and the second face respectively.
